(19) United States
(12) Patent Application Publication
(10) Pub. No.: US 2016/0066217 A1
(43) Pub. Date: Mar. 3, 2016

(54) APPARATUS AND METHOD OF INTELLIGENT RADIO ACCESS TECHNOLOGY RESELECTION IN WIRELESS COMMUNICATIONS

(71) Applicant: QUALCOMM Incorporated, San Diego, CA (US)

(72) Inventors: Parthasarathy Krishnamoorthy, Hyderabad (IN); Prashanth Mohan, Hyderabad (IN); Aravinth Rajendran, Hyderabad (IN); KrishnaKumar Vasanthasenan, Hyderabad (IN); Anand Rajurkar, Hyderabad (IN); Rashid Ahmed Akbar Attar, San Diego, CA (US); Jun Hu, San Diego, CA (US)

(21) Appl. No.: 14/472,178

(22) Filed: Aug. 28, 2014

(51) Int. Cl. H04W 36/00; H04W 36/24

(52) U.S. Cl. CPC H04W 36/0022; H04W 36/24

(57) ABSTRACT

Aspects of the present disclosure relate to a multimode user equipment (UE) that when suffering a power crunch, can intelligently reselect to another RAT to extend the battery life of the UE. The reselected RAT has a lower specified maximum transmit power relative to the currently attached RAT. Therefore, the UE may reduce its battery drain to extend its service time per charge when a call is made utilizing the reselected RAT. The UE intelligently selects the RAT that will likely consume less uplink transmit power to communicate with a base station in order to conserve battery power in a poor coverage area, when the UE is experiencing a power crunch condition.

### TECHNICAL FIELD

Aspects of the present disclosure generally relate to wireless communication systems, and more particularly, to a user equipment equipped to support multiple radio access technologies and methods of operating the same.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of a radio access technology (RAT) is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UTRAN utilizes a Wideband Code Division Multiple Access (W-CDMA) air interface. Another 3GPP standard RAT is Global System for Mobile Communications (GSM) that provides a GSM EDGE Radio Access Network (GERAN). Other examples of RAT include High Speed Packet Access (HSPA), CDMA2000, Wireless LAN (WLAN), Long Term Evolution (LTE), Worldwide Interoperability for Microwave Access (WiMAX), etc. A multimode wireless user equipment (UE) can support communication utilizing two or more RATs.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication operable at a user equipment (UE) configured to communicate utilizing two or more radio access technologies. The UE monitors a paging channel of a network utilizing a first radio access technology (RAT). If a reselection condition occurs, the UE reselects to a second RAT to reduce an anticipated power consumption of the UE based on a maximum transmit power (MAX_TX) of the second RAT. The reselection condition is such that the MAX_TX of the second RAT is lower than that of the first RAT, and the MAX_TX is specified in a corresponding specification of the second RAT.

Another aspect of the disclosure provides a user equipment (UE) configured to communicate utilizing two or more radio access technologies. The UE includes means for monitoring a paging channel of a network utilizing a first radio access technology (RAT). The UE further includes means for if a reselection condition occurs, reselecting to a second RAT to reduce an anticipated power consumption of the UE based on a maximum transmit power (MAX_TX) of the second RAT. The reselection condition is such that the MAX_TX of the second RAT is lower than that of the first RAT, and the MAX_TX is specified in a corresponding specification of the second RAT.

Another aspect of the disclosure provides a computer-readable medium including code executable by a user equipment (UE) configured to communicate utilizing two or more radio access technologies. The code causes the UE to monitor a paging channel of a network utilizing a first radio access technology (RAT). The code further cause the UE to if a reselection condition occurs, reselect to a second RAT to reduce an anticipated power consumption of the UE based on a maximum transmit power (MAX_TX) of the second RAT. The reselection condition is such that the MAX_TX of the second RAT is lower than that of the first RAT, and the MAX_TX is specified in a corresponding specification of the second RAT.

Another aspect of the disclosure provides a user equipment (UE) including at least one processor, a communication interface coupled to the at least one processor, and a memory coupled to the at least one processor. The communication interface is configured to communicate utilizing a first radio access technology (RAT) and a second RAT. The at least one processor when executing code stored in the memory, is configured to monitor a paging channel of a network utilizing the first RAT. If a reselection condition occurs, the processor is further configured to reselect to the second RAT to reduce an anticipated power consumption of the UE based on a maximum transmit power (MAX_TX) of the second RAT. The reselection condition is such that the MAX_TX of the second RAT is lower than that of the first RAT, and the MAX_TX is specified in a corresponding specification of the second RAT.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a multimode user equipment (UE) located in an area serviced by two or more RATs in accordance with aspects of the disclosure.

FIG. 2 is a block diagram illustrating an example of a telecommunications system providing multiple RATs in accordance with aspects of the disclosure.

FIG. 3 is a diagram illustrating an example of an access network in accordance with aspects of the disclosure.

FIG. 4 is a diagram illustrating an example of a radio protocol architecture for the user and control plane in accordance with aspects of the disclosure.

FIG. 5 is a block diagram illustrating a multimode UE capable of intelligently switching between RATs based on the respective specified maximum uplink transmit powers of the RATs in accordance with aspects of the disclosure.

FIG. 6 is a block diagram illustrating an example of a hardware implementation for an apparatus employing a processing system in accordance with an aspect of the disclosure.

FIG. 7 is a flow chart illustrating an intelligent RAT reselection method in accordance with an aspect of the disclosure.

FIG. 8 is a signal flow diagram illustrating a UE performing inter-RAT reselection in accordance with an aspect of the disclosure.

FIG. 9 is a flow chart illustrating an intelligent RAT reselection method in accordance with an aspect of the disclosure.

FIG. 10 is a flow chart illustrating an intelligent RAT reselection method in accordance with an aspect of the disclosure.

FIG. 11 is a flow chart illustrating a method of selecting a target RAT during reselection in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure relate to a multimode user equipment (UE) that when suffering a power crunch, can intelligently reselect to another RAT to extend the battery life of the UE. The reselected RAT has a lower specified maximum transmit power (defined in the relevant specification or standard) relative to the currently attached RAT. Therefore, the UE may reduce its battery drain to extend its service time per charge when a call is made utilizing the reselected RAT. The UE intelligently selects the RAT that will likely consume less uplink transmit power to communicate with a base station in order to conserve battery power in a poor coverage area, when the UE is experiencing a power crunch condition.

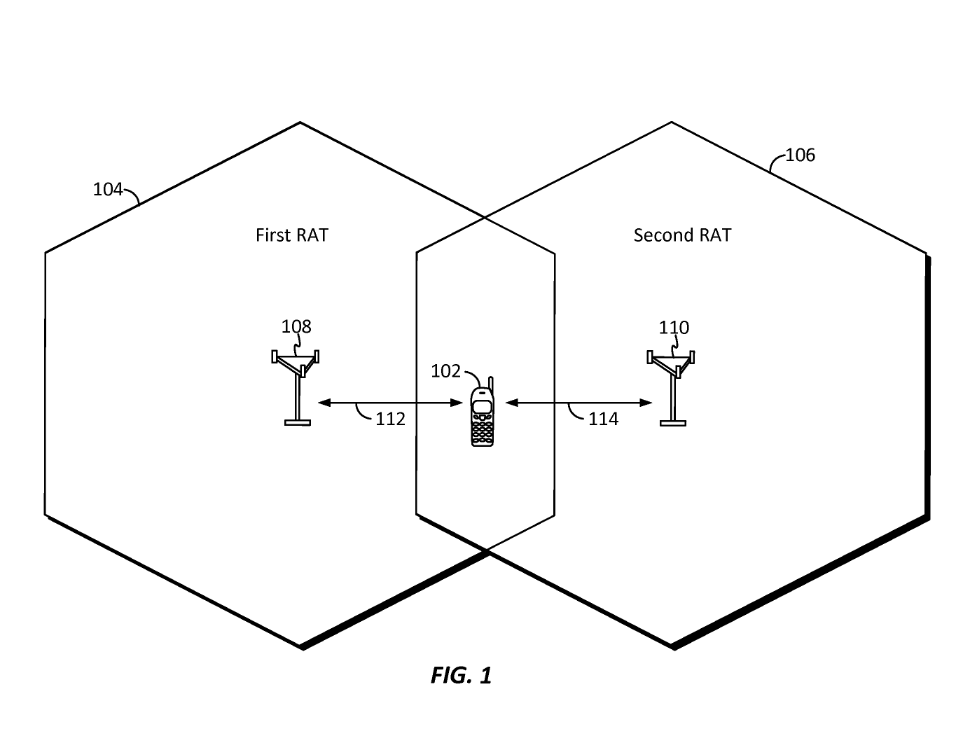

FIG. 1 is a diagram illustrating a multimode UE 102 located in an area serviced by two or more RATs such as a first RAT 104 (first cell) and a second RAT 106 (second cell) in accordance with aspects of the disclosure. In one non-limiting example, the first RAT 104 may be GSM, and the second RAT 106 may be W-CDMA. The first RAT 104 is associated with a first base station 108, and the second RAT 106 is associated with a second base station 110. In some examples, the first base station and second base station may be the same base station. In other examples, the UE 102 may be located in an area serviced by multiple second RATs (e.g., GSM, W-CDMA, LTE, etc.). However, only one second RAT 106 is shown in FIG. 1 for clarity. The coverage areas of the first RAT 104 and second RAT 106 may be partially overlapped or completely overlapped.

When the UE 102 is camped on a particular cell utilizing one of the RATs, it can establish an uplink connection with the base station. For example, when the UE 102 is utilizing the first RAT 104, the UE 102 can establish a first connection 112 with the base station 108. When the UE 102 is utilizing the second RAT 106, the UE 102 can establish a second connection 114 with the base station 110. In general, the maximum uplink transmit power of the UE is specified in the corresponding standard or specification of that particular RAT. For GSM, the maximum uplink transmit power is 2 Watts (33 dBm) in GSM 850/900 and 1 Watt in GSM 1800/1900. For W-CDMA, the maximum uplink transmit power is 0.25 Watts (24 dBm). A UE's output power should not exceed these maximum uplink transmit power limits to be compliant with the standards. In the related art, even if the UE 102 is experiencing a power crunch (i.e., low battery), the UE will remain connected on the current RAT (e.g., GSM) which might have a higher maximum uplink transmit power compared to the other available RATs (e.g., W-CDMA) in the same coverage area.

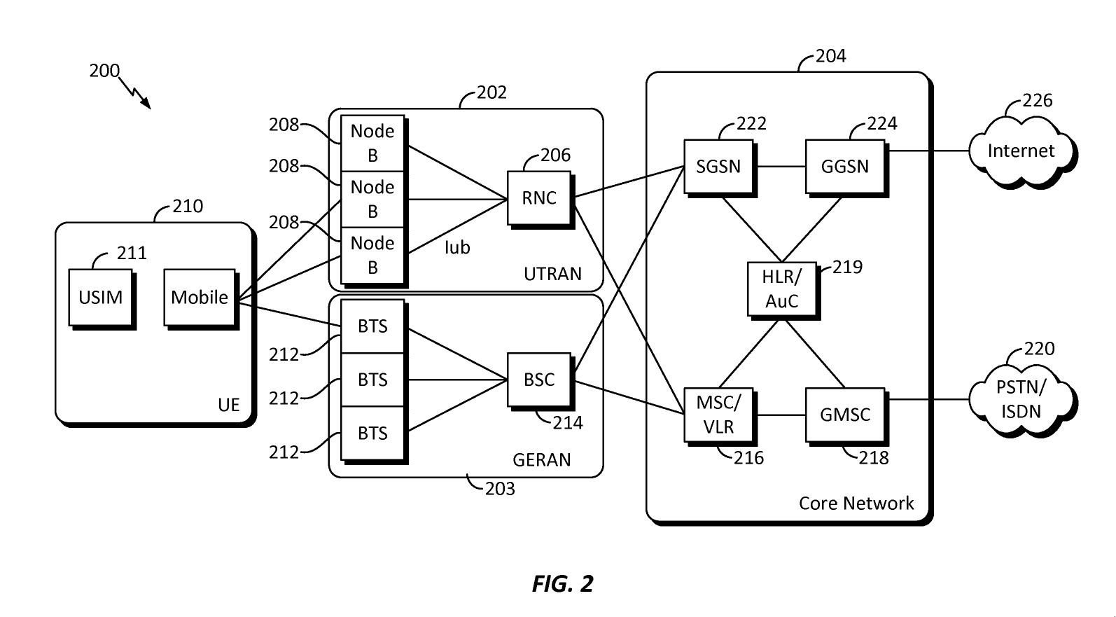

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) network 200. The UMTS network 200 includes three interacting domains: a core network 204, a UTRAN 202, a GERAN 203, and a multimode UE 210. In one example, the UE 210 may be any of the UEs of FIGS. 1, 3, 5, 6, and/or 8. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNS's), each controlled by a respective Radio Network Controller (RNC) such as an RNC 206. Here, the UTRAN 202 may include any number of RNCs and RNS's. The RNC 206 is an apparatus responsible for, among other things, assigning, reconfiguring, and releasing radio resources within the RNS. The RNC 206 may be interconnected to other RNCs (not shown) in the UTRAN 202 through various types of interfaces such as a direct physical connection, a virtual network, or the like using any suitable transport network.

In some aspects of the disclosure, the UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a multimode UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

The geographic region covered by an RNS may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in an RNS; however, the RNS may include any number of wireless Node Bs. The Node Bs 208 provide wireless access points to the core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a tablet, a wearable computing device (e.g., a smartwatch, a health or fitness tracker, etc.), an appliance, a sensor, a vending machine, or any other similar functioning devices. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) or SIM 211, which stores the subscriber's identity and provides a user's subscription information to a network as well as performing other security and authentication roles. In one aspect of the disclosure, the UE 210 may have multiple USIMs, which may be associated with different subscriptions or networks/RATs. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The GERAN 203 provides for GSM access and includes a number of BTS's 212 and a BSC 214. However, the GERAN 203 may include any number of BTS's and BSCs. In some aspects of the disclosure, the GERAN 203 may utilize a time division multiple access (TDMA) air interface, such as one defined in the GSM standard. The UE 210 can be in communication with one or more of the BTS's 212 utilizing the second SIM 211B.

The core network 204 can interface with one or more access networks, such as the UTRAN 202 and GERAN 203. As shown, the core network 204 is a UMTS core network. However, as those skilled in the art will recognize, the various concepts presented throughout this disclosure may be implemented in other suitable access networks, to provide UEs with access to types of core networks other than UMTS networks such as CDMA2000, Long Term Evolution (LTE) networks, etc.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with an MSC 216 and a GMSC 218. In some applications, the GMSC 218 may be referred to as a media gateway (MGW). One or more RNCs, such as the RNC 206, may be connected to the MSC 216. The MSC 216 is an apparatus that controls call setup, call routing, and UE mobility functions. The MSC 216 also includes a visitor location register (VLR) that contains subscriber-related information for the duration that a UE is in the coverage area of the MSC 216. The GMSC 218 provides a gateway through the MSC 216 for the UE to access a circuit-switched network 220. The GMSC 218 includes a home location register (HLR) 219 containing subscriber data, such as the data reflecting the details of the services to which a particular user has subscribed. The HLR is also associated with an authentication center (AuC) that contains subscriber-specific authentication data. When a call is received for a particular UE, the GMSC 218 queries the HLR 219 to determine the UE's location and forwards the call to the particular MSC serving that location.

The illustrated core network 204 also supports packet-switched data services with a serving GPRS support node (SGSN) 222 and a gateway GPRS support node (GGSN) 224. General Packet Radio Service (GPRS) is designed to provide packet-data services at speeds higher than those available with standard circuit-switched data services. The GGSN 224 provides a connection for the UTRAN 202 and GERAN 203 to a packet-based network 226. The packet-based network 226 may be the Internet, a private data network, or some other suitable packet-based network. The primary function of the GGSN 224 is to provide the UEs 210 with packet-based network connectivity. Data packets may be transferred between the GGSN 224 and the UEs 210 through the SGSN 222, which performs primarily the same functions in the packet-based domain as the MSC 216 performs in the circuit-switched domain.

In some examples, the UE 210 may support three or more RATs. In one particular example, the illustrated UE 210 is capable of utilizing both W-CDMA and GSM. In further examples, the UE 210 can support additional RATs including LTE, CDMA2000, Wi-MAX, Wi-Fi, Bluetooth, or any other suitable RATs.

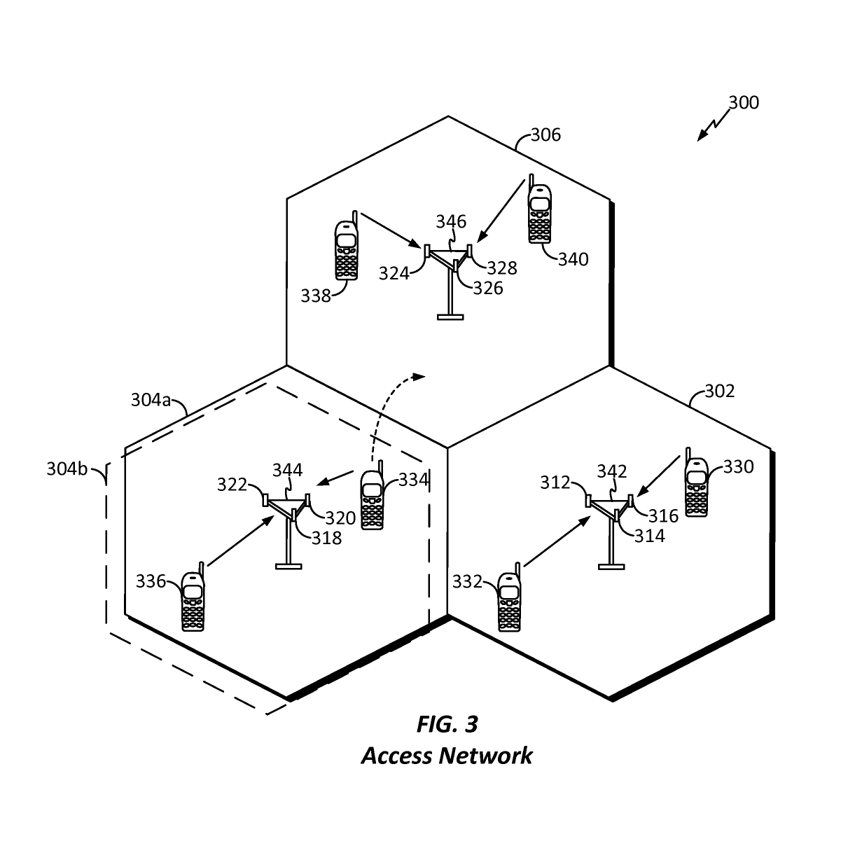

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with a frequency, scrambling code, etc. That is, the illustrated geographically-defined cells 302, 304, and 306 may each be further divided into a plurality of cells, e.g., by utilizing different scrambling codes. For example, a first cell may utilize a first scrambling code, and a second cell, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to one or more core network (e.g., core network 204 of FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set, that is, a list of cells to which the UE 336 is simultaneously connected (i.e., the UTRAN cells that are currently assigning a downlink dedicated physical channel (DPCH) or fractional downlink dedicated physical channel (F-DPCH) to the UE 336 may constitute the Active Set). In some aspects of the disclosure, any of the UEs of FIG. 3 may be a multimode device capable of supporting multiple RATs such as W-CDMA and GSM.

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 210 and the core network 204 (referring to FIG. 2), and may include circuit switched and packet switched protocols. The AS provides the lower layers, for signaling between the UTRAN 202/GERAN 203 and the UE 210, and may include a user plane and a control plane. Here, the user plane or data plane carries user traffic, while the control plane carries control information (i.e., signaling).

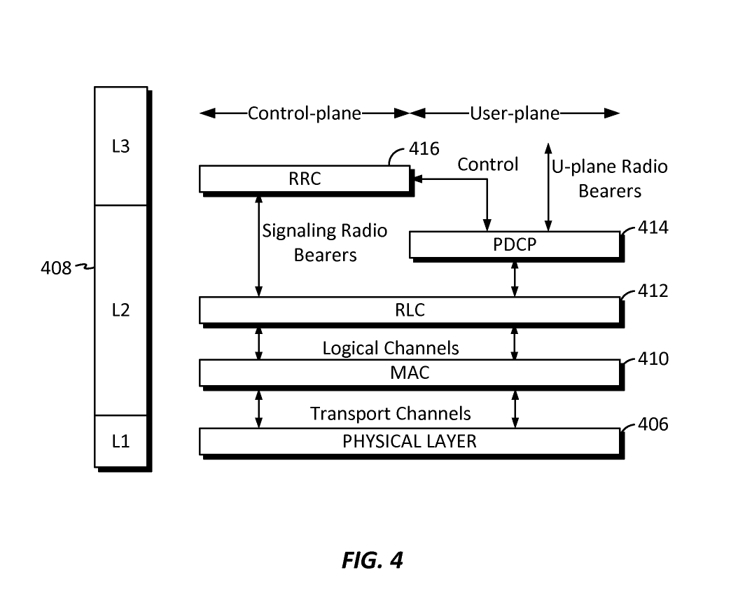

Turning to FIG. 4, the AS is shown with three layers: Layer 1 (L1), Layer 2 (L2), and Layer 3 (L3). Layer 1 is the lowest layer and implements various physical layer signal processing functions. Layer 1 will be referred to herein as the physical layer 706. The data link layer, called Layer 2 408, is above the physical layer 406 and is responsible for the link between the UE and Node B over the physical layer 406. In one aspect of the disclosure, the protocol stack of FIG. 4 may be implemented by any of the UEs illustrated in FIGS. 1, 2, 3, 5, 6, and/or 8.

At Layer 3, the radio resource control (RRC) layer 416 handles the control plane signaling between the UE and the Node B. RRC layer 416 includes a number of functional entities for routing higher layer messages, handling broadcasting and paging functions, establishing and configuring radio bearers, etc.

In the illustrated air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities. The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

Referring back to FIG. 1, after a long voice call using one RAT, the battery of a UE 102 may be depleted to a certain level (less than X % battery capacity, where X will be implementation specific (e.g., 20%) and dynamically configurable as well) that the UE may run out of battery in a short time for a new call. For example, the UE might be in a poor/marginal coverage area and needs to transmit at high power in order to maintain a connection with a base station. That will drain out the UE's battery relatively quickly compared to when the UE is in a good coverage area.

In one example, if the UE is using GSM lower bands (e.g., GSM 900), the UE can go up to a maximum uplink power of 2 Watts (33 dBm) under poor/marginal coverage scenarios as specified in the GSM specification. In this case, the UE's battery could be drained to a low level after a long voice call. If the UE remains camped on GSM, the UE's battery may not have enough remaining power to support an incoming or outgoing GSM call. It is because the UE may transmit at or near the maximum transmit power for the GSM voice call, and it can cause the battery voltage to drop below a threshold level that can trigger the UE to shut down. However, if other RATs are available in the same coverage area, the UE can consider them and attempt to switch to another RAT whose corresponding maximum uplink transmit power is lower compared to the existing attached RAT.

In one example, W-CDMA coverage may be available in the same area where the UE is currently camped on GSM. The W-CDMA standard may specify a maximum uplink transmit power limit of 0.25 Watts (24 dBm) that is lower than that of GSM. Therefore, in certain conditions, it will be beneficial for the UE to switch to W-CDMA in order to extend its operating time for making and receiving calls. In another example, CDMA2000 coverage may be available in the same area. The CDMA2000 standard may specify a maximum uplink transmit power limit of 0.20 Watts (23 dBm) that is also lower than that of GSM. The present disclosure, however, is not limited to these RATs. When the UE is already transmitting at a high uplink power in the currently attached RAT (e.g., GSM), it is an indication of undesirable channel conditions and/or poor coverage with the current RAT. Therefore, it may be beneficial for the UE to switch to other another RAT that has a lower maximum uplink transmit power specified by the corresponding standard. In some example, the switch over between RATs may be performed when the UE is in an idle mode so that call interruption may be reduced or avoided. In the idle mode, for example, the UE monitors the paging channel (e.g., for any incoming call) and periodically checks whether it has camped to the most appropriate cell or not (for example, the cell with the highest signal strength and quality).

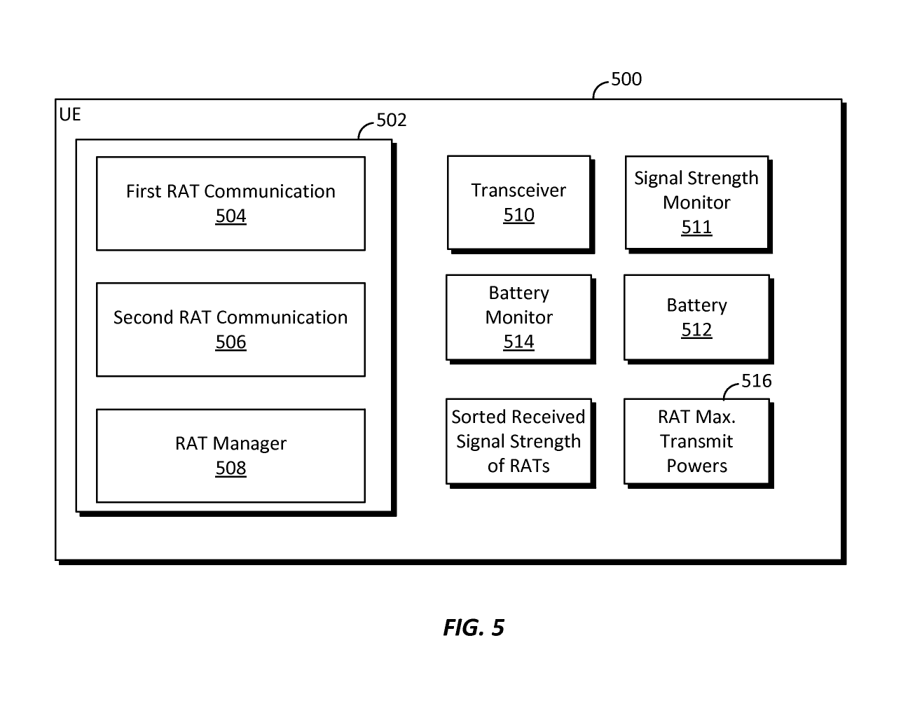

FIG. 5 is a block diagram illustrating a multimode UE 500 capable of intelligently switching between RATs based on the respective maximum uplink transmit powers of the RATs in accordance with an aspect of the disclosure. The UE 500 may be any of the UEs illustrated in FIGS. 1, 2, 3, 6, and/or 8. The maximum uplink transmit power for a particular RAT refers to the maximum transmit power of a UE stated or defined in the corresponding standard specification (e.g., 3GPP specifications for GSM, W-CDMA, LTE, and 3GPP2 specification for CDMA2000). In some examples, the multimode UE 500 can support multiple RATs such as W-CDMA, GSM, CDMA2000, LTE, Wi-Max, Wi-Fi, etc.

The UE 500 includes a multi-RAT block 502 for supporting communication with one or more networks using different RATs. For example, the multi-RAT block 502 includes a first RAT communication block 504 and a second RAT communication block 506. In one example, the first RAT communication block 504 may support GSM communication between the UE 500 and a network. In one example, the second RAT communication block 506 may support W-CDMA communication between the UE 500 and a network. In other examples, the multi-RAT block 502 may include additional RAT communication blocks, in addition to the first and second RAT communication blocks 504 and 506, for supporting other RATs. In some examples, each of the first and second communication blocks may support more than one RAT. The multi-RAT block 502 further includes a RAT manager 508 for managing and controlling the RAT communication blocks and deciding which RAT should be used for communication (e.g., initiating or receiving a new call) based on a number of factors including the current location of the UE, received signal strength (or measured signal strength) of the RATs, maximum uplink transmit powers of the RATs, battery power reserve, an operating state of the UE (e.g., in an idle mode or active call), etc.

The UE 500 further includes a signal strength monitor 511 for determining the received signal strength (or measured signal strength) of the various RATs. The received signal strength may serve as a criterion for selecting the RATs. In one example, the received signal strength may be the received common pilot channel (CPICH) E_{c}/Nₒ value discussed in the 3GPP Technical Specification 25.304 (Release 12), which is incorporated herein by reference. The CPICH E_{c}/Nₒ value refers to the received energy per chip divided by the power density in the band of the received CPICH signal. For a RAT to be selected, its measured signal strength should be above a certain threshold. In one example, the threshold may be referred to as F_{DD}_{_{—}}Q_{MIN}. The F_{DD}_{_{—}}Q_{MIN} value refers to a minimum threshold signal strength value for frequency division duplex mode communications. The F_{DD}_{_{—}}Q_{MIN} may provide a threshold CPICH E_{c}/Nₒ value for selecting a certain RAT. If the CPICH E_{c}/Nₒ value of a particular RAT exceeds F_{DD}_{_{—}}Q_{MIN}, then this RAT may be considered to have sufficient signal strength for reselection purpose.

Another example of measured signal parameter that may be used for determining the received signal strength is the CPICH Received Signal Code Power (RSCP) value, as discussed in the 3GPP Technical Specification 25.304. The CPICH RSCP value represents the received power on one of the CPICH codes, after despreading, measured on the pilot bits of the primary CPICH. In this case, the threshold may be referred to as Srxlevmin, which specifies a minimum acceptable CPICH RSCP value. The Srxlevmin threshold may be derived from parameters specified by the network, such as Qrxlevmin and UE_TX_PWR_MAX_RACH. The UE_TX_PWR_MAX_RACH parameter generally refers to the maximum transmit power level that can be used by a UE when accessing the cell on a Random Access Channel (RACH). If the CPICH RSCP value of a particular RAT exceeds Srxlevmin, and this RAT may be considered to have sufficient signal strength for reselection purpose.

The UE 500 further includes one or more transceivers 510 that can be utilized to transmit and receive signals to/from a network utilizing any of the RATs supported by the UE 500. In some aspects of the disclosure, each transceiver 510 may include one or more modems, transmitters, receivers, and other known transceiver circuitry. The UE 500 further includes a battery 512 to power the UE 500, for example, when it is not connected to a power grid. The UE 500 further includes a battery monitor 514 for monitoring the condition of the battery 512, for example, including voltage, current, and battery power reserve (e.g., State of Charge (SOC) or Depth of Discharge (DOD)). In various aspects of the disclosure, the UE 500 may reselect from a first (current) RAT to a second RAT in order to prolong its battery operating time in certain reselection conditions, which will be described in detail below. The various blocks and components of the UE 500 may be implemented in software, hardware, firmware, or any combinations thereof.

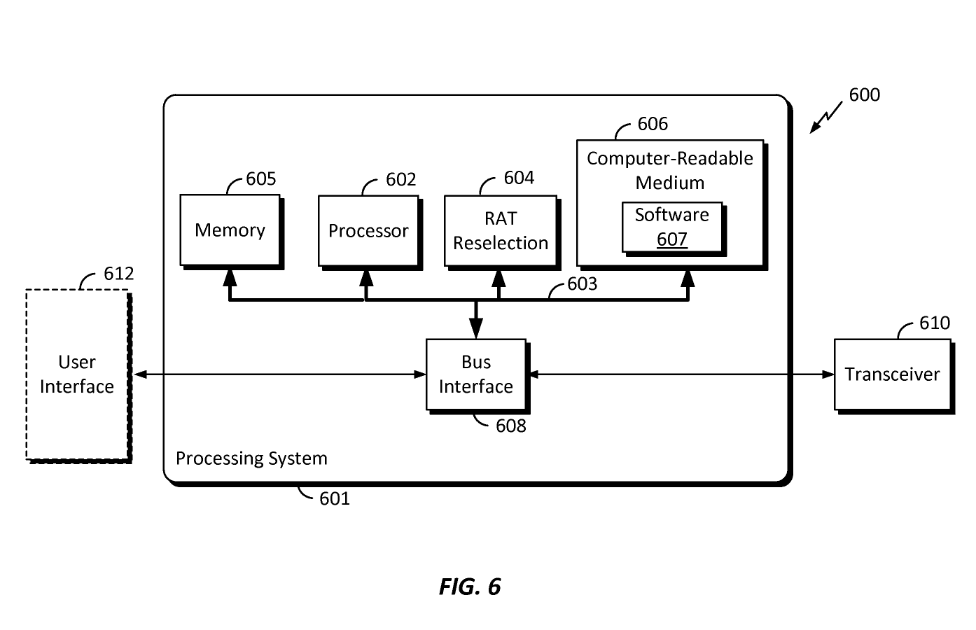

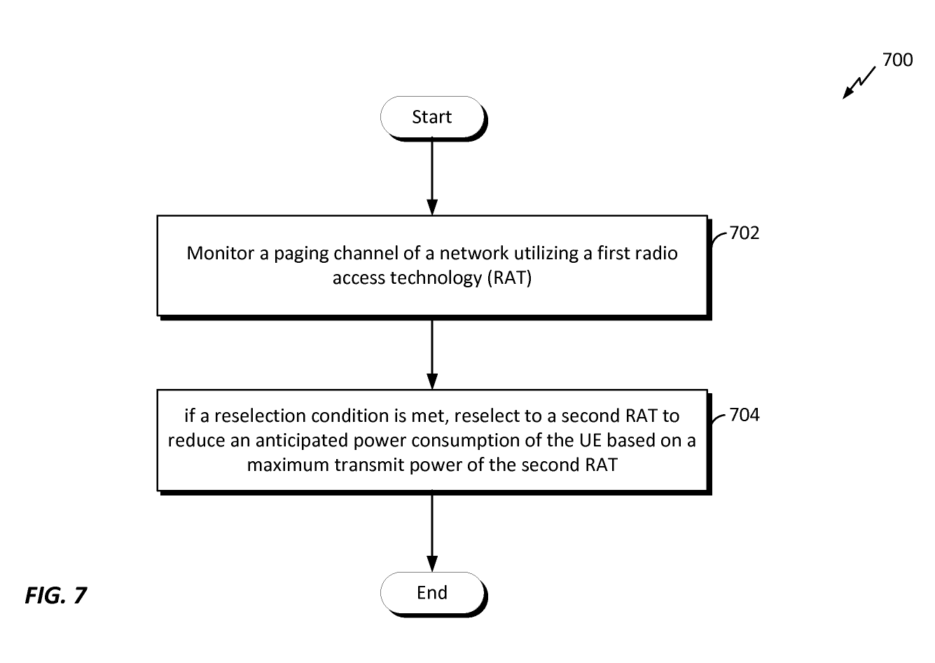

FIG. 6 is a diagram illustrating an example of a hardware implementation for an apparatus 600 employing a processing system 601. In accordance with various aspects of the disclosure, an element, or any portion of an element, or any combination of elements may be implemented with a processing system 601 that includes one or more processors 602. For example, the apparatus 600 may be any of the UEs illustrated in FIGS. 1, 2, 3, 5, and/or 8. Examples of processors 602 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The apparatus 600 includes a RAT reselection block 604 that may include all or some of the components illustrated in FIG. 5. The processor 602 and/or RAT reselection block 604, as utilized in an apparatus 600, may be used to implement any one or more of the methods, steps and processes described in this specification and illustrated in FIGS. 7-11. In some aspects of the disclosure, the RAT reselection block 604 may be implemented by the processor 602 when executing software 607 stored in a computer-readable medium 606.

In this example, the processing system 601 may be implemented with a bus architecture, represented generally by the bus 603. The bus 603 may include any number of interconnecting buses and bridges depending on the specific application of the processing system 601 and the overall design constraints. The bus 603 links together various circuits including one or more processors (represented generally by the processor 602), the RAT reselection block 604, a memory 605, and computer-readable media (represented generally by the computer-readable medium 606). The bus 603 may also link various other circuits such as timing sources, peripherals, voltage regulators, and power management circuits, which are well known in the art, and therefore, will not be described any further. A bus interface 608 provides an interface between the bus 603 and a transceiver 610. The transceiver 610 provides a means for communicating with various other apparatus over a transmission medium. For example, the transceiver 610 may include one or more modems, RF circuitries, etc., for supporting connections with multiple subscriptions using the same or different RATs (e.g., RATs 104 and 106 of FIG. 1). Depending upon the nature of the apparatus, a user interface 612 (e.g., keypad, display, speaker, microphone, joystick, touchpad, touchscreen, and motion/gesture sensor) may also be provided.

The processor 602 is responsible for managing the bus 603 and general processing, including the execution of software 607 stored on the computer-readable medium 606. For example, the software 607, when executed by the processor 602 and/or RAT Reselection block 604, causes the processing system 601 to perform the various functions described throughout this specification and illustrated in the drawings for any particular apparatus. For example, the software 607 may include codes when executed by the processor 602 and/or RAT reselection block 604 perform the various functions, steps, and processes described in FIGS. 7-11. The computer-readable medium 606 may also be used for storing data that is manipulated by the processor 602 and/or RAT reselection block 604 when executing software.

One or more processors 602 in the processing system may execute various software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 606 may reside in the processing system 601, external to the processing system 601, or distributed across multiple entities including the processing system 601. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 7 is a flow chart illustrating an intelligent RAT reselection method 700 in accordance with an aspect of the present disclosure. The method 700 may be performed by any of the UEs illustrated in FIGS. 1, 2, 3, 5, 6, and/or 8. According to the method 700, when a UE is suffering a power crunch condition, it can intelligently reselect to another available RAT in order to extend the operating time of the UE for making calls or other power intensive activities. A power crunch condition occurs when the UE's battery power reserve is below a certain threshold such that a new call or other power intensive activities may trigger the UE to power down (e.g., triggered by a sufficiently low battery voltage). It is because the UE generally uses more power in an active call than in standby or idle, and the battery current consumption will be higher. The battery power reserve may be determined based on various battery parameters such as a battery voltage, remaining Ampere-Hours capacity, an SOC, and/or a DOD The threshold of the battery power reserve may be determined in accordance with one or more of the following parameters including, for example, battery voltage, remaining Ampere-Hours capacity, etc., The threshold may be implementation specific. In some aspects of the disclosure, the threshold may be dynamically (i.e., not fixed) configurable.

Referring to FIG. 7, at block 702, the UE may utilize a first RAT communication block 504 and a transceiver 510 (see FIG. 5) to monitor a paging channel of a network utilizing a first RAT. The first RAT may be GSM. In GSM, the UE monitors a Common Control Channel (CCCH) including a Paging Channel (PCH) for incoming pages. In one example, the UE may be in an idle mode and monitors the network for any incoming call of the first RAT. At block 704, if a reselection condition is met, a RAT manager 508 of the UE (see FIG. 5) may reselect to a second RAT to reduce an anticipated power consumption of the UE based on a maximum transmit power (MAX_TX) of the second RAT. In one example, the anticipated power consumption refers to the power consumed by a UE when it is used for a new voice call or other power intensive communication activities (e.g., audio and/or video streaming, uploading and/or downloading large files). The UE may utilize a second RAT communication block 506 and the transceiver 510 to communicate with the network utilizing the second RAT. The second RAT may be W-CDMA. In one example, the reselection condition occurs when the MAX_TX of the second RAT is lower than that of the first RAT. The MAX_TX is defined in the corresponding specification of the RAT. For GSM, the MAX_TX is 2 Watts (33 dBm) as defined in the various 3GPP/ETSI specifications. For W-CDMA, the MAX_TX is 0.25 Watts (24 dBm) as defined in the various 3GPP specifications. For CDMA2000, the MAX_TX is 0.20 Watts (23 dBm) as defined in the various 3GPP2 specifications. The method 700, however, is not limited to only GSM, W-CDMA, and CDMA2000 and may be applied using other RATs.

In one aspect of the disclosure, the reselection condition further includes that the battery power reserve of the UE is below certain a certain threshold (T_{B}), and the second RAT provides a reasonable coverage to the UE such that a voice call can be sustained with the second RAT. For example, the UE may utilize a battery monitor 514 to monitor its battery 512. The second RAT has reasonable coverage when the received signal strength (e.g., CPICH E_{c}/Nₒ or CPICH RSCP) at the UE is greater than a minimum threshold (M_{TH}). The T_{B} and M_{TH} values are implementation specific and may be any suitable values depending on the RAT being used. For example, the M_{TH} may be F_{DD}_{_{—}}Q_{MIN} or Qrxlevmin. In addition, if the UE does not find an available RAT with a lower MAX_TX than the currently camped RAT, then the UE may continue on the current RAT. In some aspects of the disclosure, the UE reselect to another RAT on the condition that the UE is in an idle mode and not in a voice call, ensuring no interruption to the ongoing voice call. The intelligent RAT reselection method 700 will be described in more detail below with an illustrative example.

### Illustrative Example

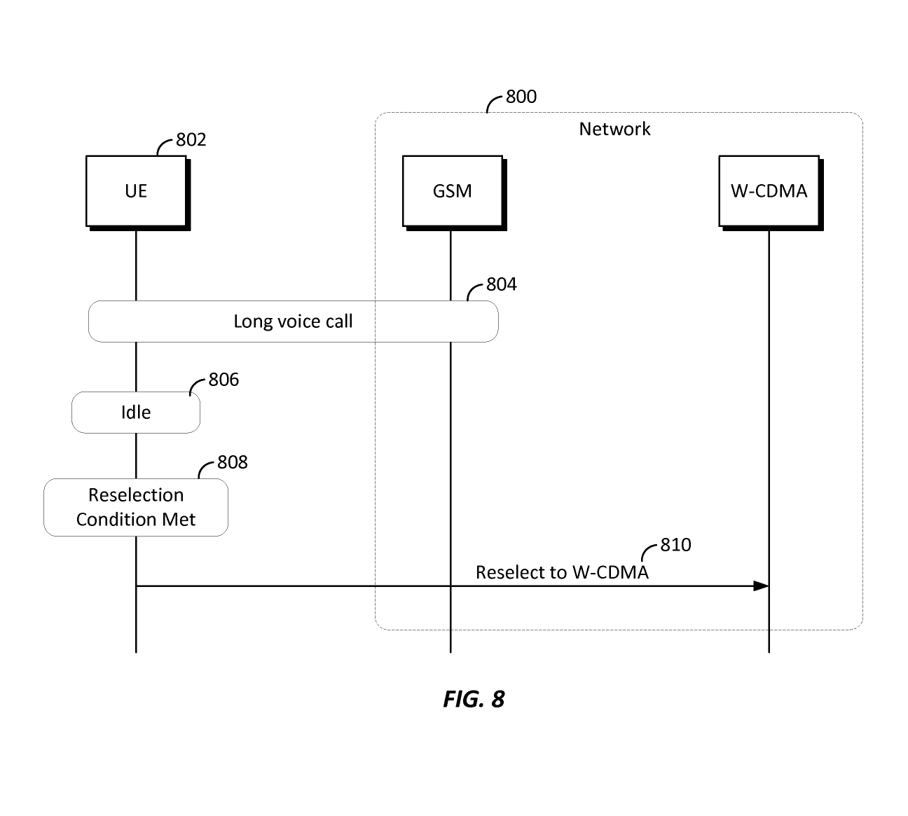

FIG. 8 is a signal flow diagram illustrating a UE 800 performing an inter-RAT reselection in accordance with an aspect of the disclosure. The UE 800 may be any of the multimode UEs illustrated in FIGS. 1, 2, 3, 5, and/or 6. Here, a network 800 supports both GSM and W-CDMA. It is assumed that the UE 802 was used for a long voice call 804 with the network utilizing GSM. The UE 802 might be located in an area with poor signal coverage. Therefore, the UE's output power could be at or near the maximum transmit power (e.g., MAX_TX) specified in the GSM specification during the long voice call 804. Therefore, the battery of the UE 802 might be substantially depleted. After the long voice call, the UE 802 is in an idle mode 806. In the idle mode, the UE 802 may monitor its battery status and GSM paging messages. At a certain time, the UE 802 needs to handle a new call with the network 800. If a reselection condition 808 is met, the UE 802 may reselect to W-CDMA 810 that has a lower maximum transmit power than GSM. For example, in the worst channel conditions, the UE's maximum transmit power will be less for W-CDMA relative to GSM (e.g., 0.25 Watts for WCDMA vs. 2 Watts for GSM). Thus, the UE 800 may reduce an anticipated power consumption in order to handle the new call.

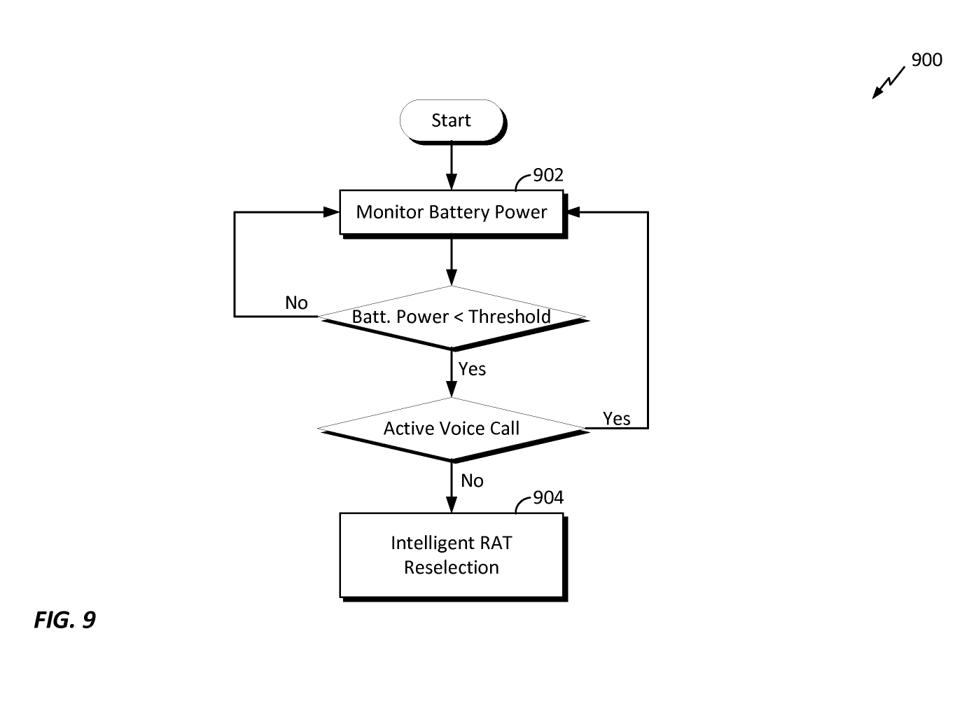

FIG. 9 is a flow chart illustrating an intelligent RAT reselection method 900 in accordance with an aspect of the present disclosure. The method 900 may be performed by any of the multimode UEs illustrated in FIGS. 1, 2, 3, 5, 6, and/or 8. In one example, the method 900 may be performed at block 704 of FIG. 7. At block 902, a multimode UE may utilize a battery monitor 514 (see FIG. 5) to monitor its battery power reserve. In one example, the UE may be camped on GSM. If the battery power reserve (i.e., remaining battery power) is below a certain threshold, the UE may utilize a RAT manager 508 (see FIG. 5) to check whether or not it is in an active voice call; otherwise, the UE may return to block 902. Alternatively, if the battery power reserve is not below a certain threshold, the UE may stop monitoring the battery power for a certain period of time and check the battery power reserve again before a new voice call is made. At block 904, if the UE is not in an active voice call, the UE may utilize the RAT manager 508 to initiate or perform intelligent RAT reselection such that the UE can reselect to another RAT that has a lower maximum transmit power than that of GSM. In one example, the reselected RAT may be W-CDMA, CDMA2000, or LTE, etc.

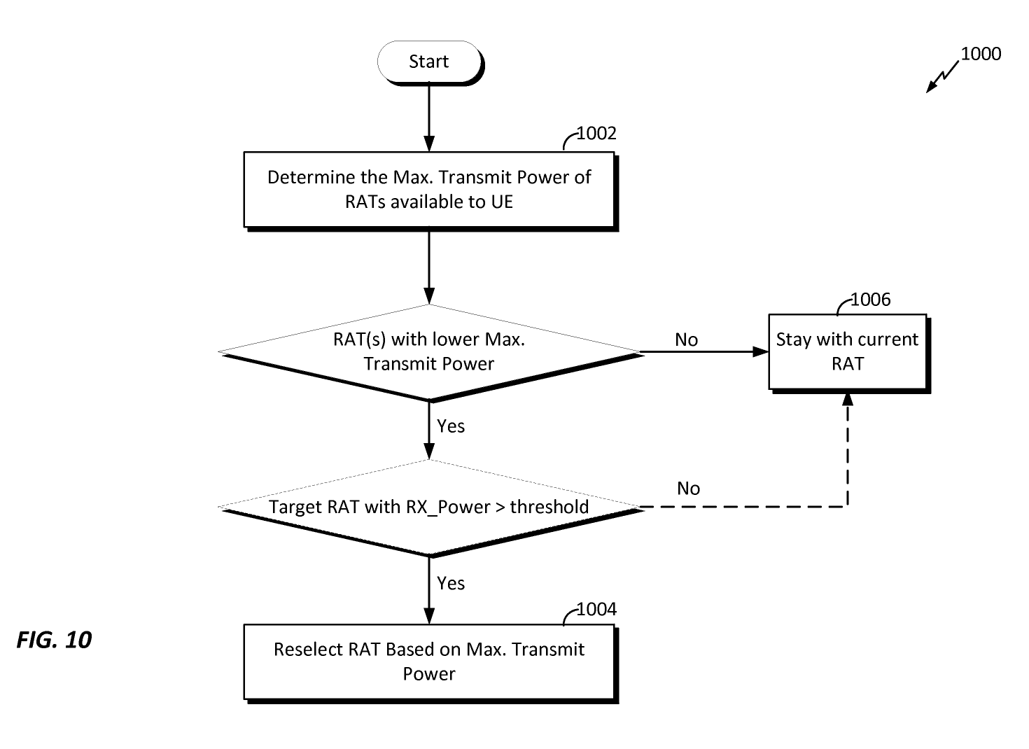

FIG. 10 is a flow chart illustrating an intelligent RAT reselection method 1000 in accordance with an aspect of the disclosure. The method 1000 may be performed by any of the multimode UEs illustrated in FIGS. 1, 2, 3, 5, 6, and/or 8. In one example, the method 1000 may be performed at block 904 of FIG. 9. In one example, the method 1000 may be performed by a UE after a long voice call, and its battery power reserve is below a certain threshold level (T_{B}). At block 1002, the UE may utilize a RAT manager 508 to determine the respective maximum transmit power (MAX_TX) of all the RATs (e.g., serving RAT and neighbor RATs) that are available to the UE at a certain location. For example, the RAT manager 508 may have a database 516 (se FIG. 5) that stores the MAX_TX of all RATs supported by the UE. The MAX_TX is defined in the corresponding specifications or standards of the RATs (e.g., ETSI or 3GPP or 3GPP2 specification). If there is any available RAT with a lower MAX_TX than the serving RAT, the UE may reselect to that RAT at block 1004; otherwise, the UE stays with the current serving RAT at block 1006. In one example, the UE may utilize the RAT manager 508 to perform RAT reselection. In some aspects of the disclosure, the UE may reselect to another RAT on the condition that the reselected RAT has a received signal strength (RX_Power) greater than a minimum threshold. The threshold of the RX_Power may be different for different RATs. In some aspects of the disclosure, the minimum threshold may be dynamically configurable (i.e., not fixed).

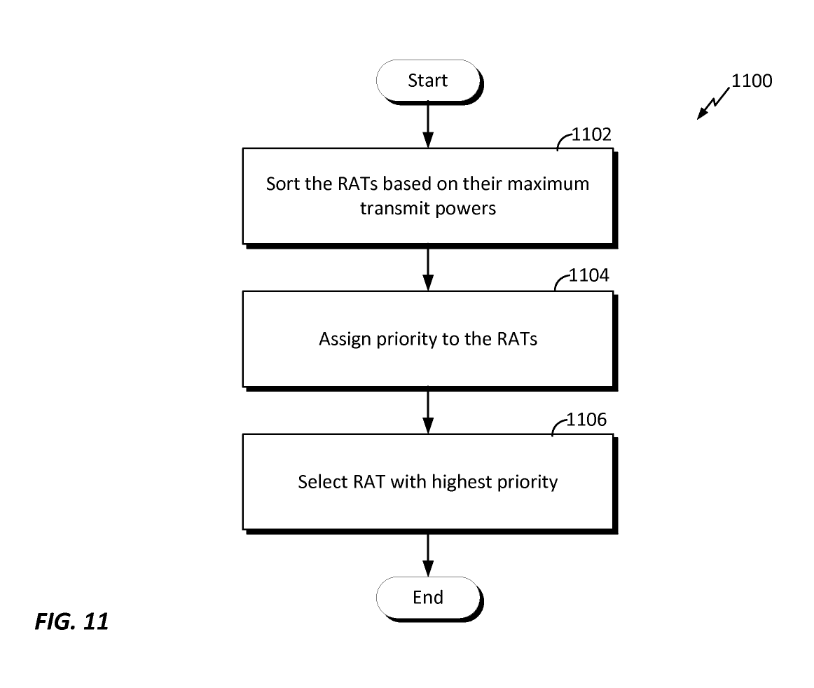

FIG. 11 is a flow chart illustrating a method 1100 of selecting a target RAT during reselection in accordance with an aspect of the disclosure. The method 1100 may be performed by any of the multimode UEs illustrated in FIGS. 1, 2, 3, 5, 6, and/or 8. In one example, the method 1100 may be performed at block 1002 of FIG. 10. At block 1102, the UE sorts the available RATs based on their maximum transmit powers. The available RATs include the serving RAT and the neighbor RAT(s) (e.g., GSM and W-CDMA). For example, the UE may utilize the RAT manager 508 to sort the available RATs. At block 1104, the UE assigns priority to the sorted RATs. For example, a first RAT (e.g., W-CDMA) with a greater maximum transmit power will have a higher priority than a second RAT (e.g., GSM) with a lower maximum transmit power. In one aspect of the disclosure, the UE may utilize the RAT manager 508 to assign the priority of the RATs. At block 1106, the UE selects the RAT with the highest priority for reselection.

Several aspects of a telecommunications system have been presented with reference to a W-CDMA/GSM system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a user equipment (UE) configured to communicate utilizing two or more radio access technologies, comprising:
monitoring a paging channel of a network utilizing a first radio access technology (RAT); and
if a reselection condition occurs, reselecting to a second RAT to reduce an anticipated power consumption of the UE based on a maximum transmit power (MAX_TX) of the second RAT,
wherein the reselection condition comprises that the MAX_TX of the second RAT is lower than that of the first RAT, and the MAX_TX is specified in a corresponding specification of the second RAT.

2. The method of claim 1, wherein the reselection condition further comprises that a battery power reserve of the UE is lower than a threshold value.

3. The method of claim 1, wherein the reselection condition further comprises that the UE is in an idle mode.

4. The method of claim 1, wherein the reselection condition further comprises that a received signal strength of the second RAT is greater than a threshold value.

5. The method of claim 1, further comprising forgoing reselection if the UE is in an active voice call.

6. The method of claim 1, further comprising:
assigning priority to the first RAT and the second RAT based on their respective MAX_TXs,
wherein the reselection condition further comprises that the second RAT has a higher priority relative to the first RAT.

7. A user equipment (UE) configured to communicate utilizing two or more radio access technologies, comprising:
means for monitoring a paging channel of a network utilizing a first radio access technology (RAT); and
means for if a reselection condition occurs, reselecting to a second RAT to reduce an anticipated power consumption of the UE based on a maximum transmit power (MAX_TX) of the second RAT,
wherein the reselection condition comprises that the MAX_TX of the second RAT is lower than that of the first RAT, and the MAX_TX is specified in a corresponding specification of the second RAT.

8. The UE of claim 7, wherein the reselection condition further comprises that a battery power reserve of the UE is lower than a threshold value.

9. The UE of claim 7, wherein the reselection condition further comprises that the UE is in an idle mode.

10. The UE of claim 7, wherein the reselection condition further comprises that a received signal strength of the second RAT is greater than a threshold value.

11. The UE of claim 7, further comprising means for forgoing reselection if the UE is in an active voice call.

12. The UE of claim 7, further comprising:
means for assigning priority to the first RAT and the second RAT based on their respective MAX_TXs,
wherein the reselection condition further comprises that the second RAT has a higher priority relative to the first RAT.

13. A computer-readable medium comprising code for causing a user equipment (UE) configured to communicate utilizing two or more radio access technologies, to:
monitor a paging channel of a network utilizing a first radio access technology (RAT); and
if a reselection condition occurs, reselect to a second RAT to reduce an anticipated power consumption of the UE based on a maximum transmit power (MAX_TX) of the second RAT,
wherein the reselection condition comprises that the MAX_TX of the second RAT is lower than that of the first RAT, and the MAX_TX is specified in a corresponding specification of the second RAT.

14. The computer-readable medium of claim 13, wherein the reselection condition further comprises that a battery power reserve of the UE is lower than a threshold value.

15. The computer-readable medium of claim 13, wherein the reselection condition further comprises that the UE is in an idle mode.

16. The computer-readable medium of claim 13, wherein the reselection condition further comprises that a received signal strength of the second RAT is greater than a threshold value.

17. The computer-readable medium of claim 13, further comprising code for causing the UE to forgo reselection if the UE is in an active voice call.

18. The computer-readable medium of claim 13, further comprising code for causing the UE to:
assign priority to the first RAT and the second RAT based on their respective MAX_TXs,
wherein the reselection condition further comprises that the second RAT has a higher priority relative to the first RAT.

19. A user equipment (UE) comprising:
at least one processor;
a communication interface coupled to the at least one processor, configured to communicate utilizing a first radio access technology (RAT) and a second RAT; and
a memory coupled to the at least one processor,
wherein the at least one processor when executing code stored in the memory, is configured to:
monitor a paging channel of a network utilizing the first RAT; and
if a reselection condition occurs, reselect to the second RAT to reduce an anticipated power consumption of the UE based on a maximum transmit power (MAX_TX) of the second RAT,
wherein the reselection condition comprises that the MAX_TX of the second RAT is lower than that of the first RAT, and the MAX_TX is specified in a corresponding specification of the second RAT.

20. The UE of claim 19, wherein the reselection condition further comprises that a battery power reserve of the UE is lower than a threshold value.

21. The UE of claim 19, wherein the reselection condition further comprises that the UE is in an idle mode.

22. The UE of claim 19, wherein the reselection condition further comprises that a received signal strength of the second RAT is greater than a threshold value.

23. The UE of claim 19, wherein the at least one processor is further configured to forgo reselection if the UE is in an active voice call.

24. The UE of claim 19, wherein the at least one processor is further configured to:
assign priority to the first RAT and the second RAT based on their respective MAX_TXs,
wherein the reselection condition further comprises that the second RAT has a higher priority relative to the first RAT.
